(19) United States
(12) Patent Application Publication
(10) Pub. No.: US 2008/0027589 A1
(43) Pub. Date: Jan. 31, 2008

(54) Remote Control Apparatus

(75) Inventors: Keiji Hiwano, Toyota-shi (JP); Tetsuya Nagasaki, Toyota-shi (JP); Atsushi Watanabe, Anjo-shi (JP); Naoki Taki, Okazaki-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-Shi (JP)

(21) Appl. No.: 11/596,412

(22) PCT Filed: Aug. 26, 2005
(86) PCT No.: PCT/JP05/16074

§ 371 Date: Nov. 13, 2006

(30) Foreign Application Priority Data
Sep. 30, 2004 (JP) 2004-288526

(51) Int. Cl. G05D 1/00

(52) U.S. Cl. 701/2

(57) ABSTRACT

A remote control apparatus for drives an openable and closable in-vehicle device to close it remotely by means of an operation by a user carried out on an operation terminal, and, upon receiving a request for driving the in-vehicle device to close it, a driving operation is carried out to open the in-vehicle device once before a deriving operation to close the same is carried out.

### TECHNICAL FIELD

The present invention relates to a remote control apparatus, and, in particular, to a remote control apparatus applied in a remote control system including an in-vehicle unit driving an openable and closable in-vehicle device such as a vehicle window, a vehicle door, or such; and an operation terminal which a vehicle user operates, and has a function to remotely drive the in-vehicle device to close it by means of operation made by the vehicle user on the operation terminal.

### BACKGROUND ART

A remote control system including a portable terminal carried and operated by a vehicle user; and an in-vehicle unit loading a vehicle window or a vehicle door to be opened or closed, is known. For example, see Japanese Laid-open Patent Application No. 2002-19548. In such a system, when the portable terminal is operated by the vehicle user, instructions for closing the in-vehicle device are transmitted to the in-vehicle unit from the portable terminal via a communication network. As a result, the in-vehicle device is actually driven and closed accordingly. According, in this system, the vehicle user can drive the openable and closable in-vehicle device remotely by operating the portable terminal even when the vehicle user is actually away from the vehicle.

### DISCLOSURE OF THE INVENTION

In this system, a remote driving operation to close the openable and closable in-vehicle device can be carried out even when the vehicle user does not exist actually in the vicinity of the vehicle. However, in such a case, it may be difficult for the user to sufficiently make a safety check before actually making a driving operation to close the in-vehicle device. Therefore, if a remote driving operation to close the in-vehicle device is carried out suddenly, a shock may be given to a person who actually rides the relevant vehicle or who exists in the vicinity of the vehicle.

The present invention has been devised in consideration of this point, and, an object of the present invention is to provide a remote control apparatus directed to a safety upon carrying out remote driving of an openable and closable in-vehicle device in particular to close it

This object is achieved by a remote control apparatus for driving an openable and closable in-vehicle device to close it remotely by means of operation made by a user on an operation terminal, wherein, upon receiving a request for driving the in-vehicle device to close it, driving operation is carried out to open the in-vehicle device once before driving operation to close the same is carried out.

In the present invention, when a request for closing the openable and closable in-vehicle device is made by a user's operation made on the operation terminal, driving operation to open the in-vehicle device is carried out once before driving operation to close the in-vehicle device. As a result, more safe and less dangerous driving operation to open the in-vehicle device is carried out from an initial position first. Thereby, a situation that a human being is caught by the in-vehicle device due to the closing operation thereof can be avoided, and thus, the safety upon closing the in-vehicle device can be improved.

In this case, the driving operation to open the in-vehicle device carried out before the driving operation to close the same may be carried out by a predetermined amount.

Further, the driving operation to open the in-vehicle device carried out before the driving operation to close the same may be carried out for a fully opened position.

Further, the driving operation to open the in-vehicle device carried out before the driving operation to close the same may be carried out for a predetermined opening position.

Furthermore, the above-mentioned object of the present invention is achieved by a remote control apparatus for driving an openable and closable in-vehicle device to close it remotely by means of operation made by a user on an operation terminal, wherein, upon receiving a request for driving the in-vehicle device to close it, driving operation is carried out to open the in-vehicle device once before driving operation to close the same is carried out, when an opening amount of the in-vehicle device has not reached a predetermined amount; while the driving operation to close the in-vehicle device is carried out without driving operation to open the same, when the opening amount of the in-vehicle device has reached the predetermined amount.

In the present invention, as mentioned above, upon receiving a request for driving the in-vehicle device to close it, driving operation is carried out to open the in-vehicle device once before driving operation to close the same is actually carried out, when an opening amount of the in-vehicle device has not reached a predetermined amount; while the driving operation to close the in-vehicle device is carried out without driving operation to open the same, when the opening amount of the in-vehicle device has reached the predetermined amount. That is, for a case where the current opening amount of the in-vehicle device is relatively large, the safety of the closing operation is ensured even when the closing operation is carried out without accompanied by opening operation in advance. On the other hand, for a case where the current opening amount of the in-vehicle device is relatively small, more safe and less dangerous driving operation to open the in-vehicle device is carried out from an initial position first. Thereby, a situation that a human being is caught by the in-vehicle device due to the closing operation thereof can be avoided, and thus, the safety upon closing the in-vehicle device can be improved.

It is noted that, in any one of the above-mentioned configurations, the driving operation to close the in-vehicle device may be carried out for a fully closed position.

In the present invention, the safety can be ensured upon carrying out driving operation to close an openable and closable in-vehicle device.

### BRIEF DESCRIPTION OF DRAWINGS

Other objects and further features of the present invention will become more apparent from the following detailed description when read in conjunction with the accompanying drawings:

FIG. 1 shows a system configuration of a remote control system according to one embodiment of the present invention;

FIG. 2 illustrates window operation when a window is remotely closed, according to the present embodiment;

FIG. 3 shows a flow chart executed in the remote control system according to the present embodiment; and

FIG. 4 illustrates window operation when a window is remotely closed, according to a variant embodiment of the present invention.

### BEST MODE FOR CARRYING OUT THE PRESENT INVENTION

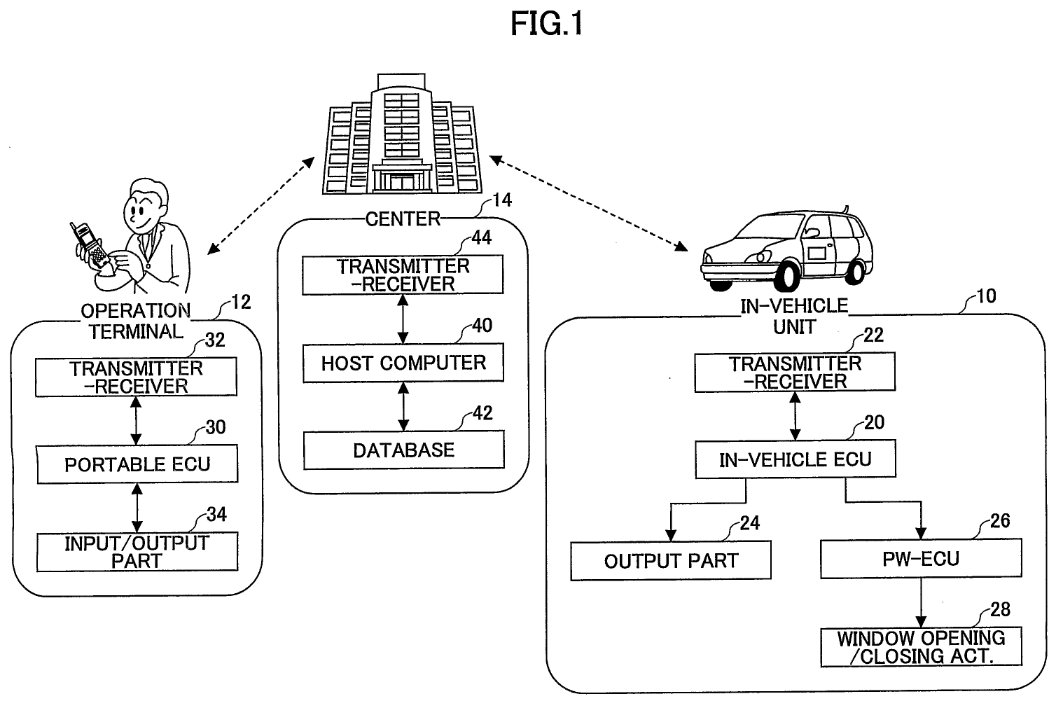

FIG. 1 shows a configuration diagram of a remote control system according to one embodiment of the present invention. The system according to the embodiment includes an in-vehicle unit 10 mounted in a vehicle; a portable terminal 12 (operation terminal) such as a cellular phone, a personal computer, a PDA or such carried by a vehicle user; and a center 14 managing information between the in-vehicle unit 10 and the operation terminal 12. The remote control system according to the embodiment is a system for remotely driving an in-vehicle device described below which the in-vehicle unit 10 has, by means of directly operating the operation terminal 12. Hereinafter, remote driving of the in-vehicle device is referred to as remote operation.

In the present embodiment, the in-vehicle unit 10 has an in-vehicle electronic control unit (simply referred to as an in-vehicle ECU hereinafter) 20 for carrying out various items of control operation. To the in-vehicle ECU 20, a transmitter-receiver 22 such as a data communication module (DCM) for carrying out radio communication is connected. The transmitter-receiver 22 has a data communication antenna, and has a function to transmit various items of information to the center 14 from the data communication antenna via a communication network; and a function to receive various items of information transmitted from the center 14 with the data communication antenna via the communication network.

The in-vehicle ECU 20 has a computer, and operates according to a software program previously stored in a storage device such as a ROM. The in-vehicle ECU 20 has a storage device for storing identification information including a telephone number of the own vehicle, a telephone number of the center and so forth, and a buffer memory for temporarily storing various items of transmission data and received data. The in-vehicle ECU 20 carries out data transmission and data reception via the transmitter-receiver 22.

To the in-vehicle ECU 20, a voice/display output part 24 is connected. The voice/display output part 24 is used for outputting voice/alarm with the use of a speaker for a person who rides the vehicle; outputting display; and also, outputting voice/alarm for a person who exists around the vehicle with the use of an electric horn, a buzzer, an external speaker or such. This voice/display outputting part 24 carries out such outputting operation according to instructions given by the in-vehicle ECU 20. The in-vehicle ECU 20 provides an instruction signal to the voice/display output part 24 when output is required.

To the in-vehicle ECU 20, a power window ECU (PW-ECU) 26 is connected. The PW-ECU 26 is a unit for controlling opening and closing of a window provided to each vehicle door with the use of a window opening/closing actuator 28 such as an electric motor. The window opening/closing actuator 28 drives the window to close it or to open it according to instructions provided by the PW-ECU 26. As will be described later, the in-vehicle ECU 20 provides a closing instruction signal to the PW-ECU 26 such that the window may be driven to be closed with the use of the window opening/closing actuator 28 when a window remote closing request signal transmitted from the center 14 is received via the transmitter-receiver 22.

It is noted that, the PW-ECU 26 has a function to detect an opening amount, i.e., how much the window is opened. Further, the PW-ECU 26 has a catching detection function to detect a matter that an object is caught between the window and the vehicle body, based on, for example, a change in a load applied to the vehicle body. Thereby, upon detecting the catching, the PW-ECU 26 stops driving of the window to close it, or drives the window to open it.

The operation terminal 12 has a portable electronic control unit (referred to as a portable ECU hereinafter) 30 for carrying out various items of control operation. To the portable ECU 30, a transmitter-receiver 32 is connected which is used for carrying out radio communication with the center 14 via a predetermined communication network. The transmitter-receiver 32 has a data communication antenna, and has a function to transmit information from the operation terminal 12 to the center 14 from the data communication antenna via the communication network; and a function to receive information transmitted from the center 14 via the communication network with the data communication antenna.

The portable ECU 30 has a computer, and operates according to a software program previously stored in a storage device such as a ROM. The portable ECU 30 has a storage device for storing identification information including an electronic mail address, a telephone number of the own terminal 12, a telephone number of the vehicle corresponding to the own terminal 12, a telephone number of the center 14 and so forth. The portable ECU 30 carries out data transmission and data reception with the transmitter-receiver 32.

To the portable ECU 30, an input/output part 34 is connected which is used by the vehicle user to carry out manual operation thereon, as well as outputting display and voice to the vehicle user. The operation terminal 12 has a web browser, and thus can obtain a web page for requesting information provided by the center 14, i.e., for example, information concerning remote operation of the in-vehicle device. From the operation terminal 12, a file or data stored in an external web server can be referred to via a communication network as a result of input operation being made on the input/output part v34, and also, contents input to the input/output part 34 can be transmitted to the web server.

The center 14 can provide a web page to the operation terminal 12 which is used to request the above-mentioned remote operation of the in-vehicle device. The center 14 has a host computer 40 having a capability to carry out high-speed information processing. The host computer 40 operates according to a software program previously stored in a storage device such as a ROM. The host computer 40 has a database 42 having a large storage capacity connected thereto. In the database 42, customer information is stored including identification information of a normal user of the vehicle who is also a user of the center 14, an electronic mail address, a telephone number of the operation terminal 12, identification information and telephone number of the vehicle, and so forth.

To the center 14, a transmitter-receiver 44 is connected which is used to carry out radio communication with the in-vehicle unit 10 and the operation terminal 12 via a predetermined communication network. The transmitter-receiver 44 has a data communication antenna, and has a function to transmit information from the center 14 to the in-vehicle unit 10 and the operation terminal 12 from the data communication antenna via the communication network; and a function to receive information transmitted from the in-vehicle unit 10 and the operation terminal 12 via the communication network with the data communication antenna. The host computer 40 of the center 14 carries out data transmission and data reception of data with transmitter-receiver 44.

Operation of the remote control system in the present embodiment is described now.

In the present embodiment, the vehicle user starts up the web browser by operating the input/output part 34 of the operation terminal 12, in order to completely close the window of the vehicle door by driving the window opening/closing actuator 28 for the purpose of avoiding a theft, voluntarily, or in response to being notified of a power window operation failure via the operation terminal 12 from the center 14, especially after leaving the vehicle and then being away therefrom. The center 14 stores a format for the vehicle user to request remote operation for remotely driving the window opening/closing actuator 28 which the in-vehicle unit 10 has, from operation made by the vehicle user on the operation terminal 12. The operation terminal 12 requests the center 14 to provide the web page for requesting remote operation, by connecting with the center 14 via the communication network, according to operation made by the vehicle user, in a state of the web browser having been started up. The center 14 responds to the request from the operation terminal 12, and provides the web page for the vehicle user to request remote operation, to the operation terminal 12. The operation terminal 12 thus obtains the web page for requesting remote operation.

On this web page, at least an item of window remote closing operation for closing the window, for which remote control can be carried out by means of operation of the operation terminal 12 by the vehicle user, is provided. The operation terminal 12 determines whether or not the vehicle user requests window remote closing operation, based on whether or not a check box provided for the window remote closing operation is checked by the vehicle user. When a transmission request is made in a state of the above-mentioned check box being checked as a result of the vehicle user operating the input/output part 34, the operation terminal 12 transmits a remote operation request signal to the center 14 to notify the center 14 that the window remote closing operation is requested corresponding to the checking of the check box.

Upon receiving the remote operation request signal for window closing transmitted by the operation terminal 12 after providing the web page for the vehicle user to request window remote closing operation to the operation terminal 12, the center 12 transmits a remote operation request signal, indicating that window remote closing operation is requested as a result of operation carried out on the operation terminal 12, to the in-vehicle unit 10 corresponding to the operation terminal 12. Upon receiving the remote operation request signal for window closing transmitted from the center 14, the in-vehicle unit 10 uses the window opening/closing actuator 28 to carry out processing of driving the window of each vehicle door to completely close it.

Thus, in the remote control system according to the present embodiment, driving of the window provided to each vehicle door to close it can be remotely carried out via the center 14 as a result of the operation terminal 12 being operated. Accordingly, in the system according to the present embodiment, the vehicle user can carry out window remote closing operation even from a position far away from the vehicle without actually riding in the vehicle. Thus, window closing by means of the window opening/closing actuator 28 can be carried out by remote operation.

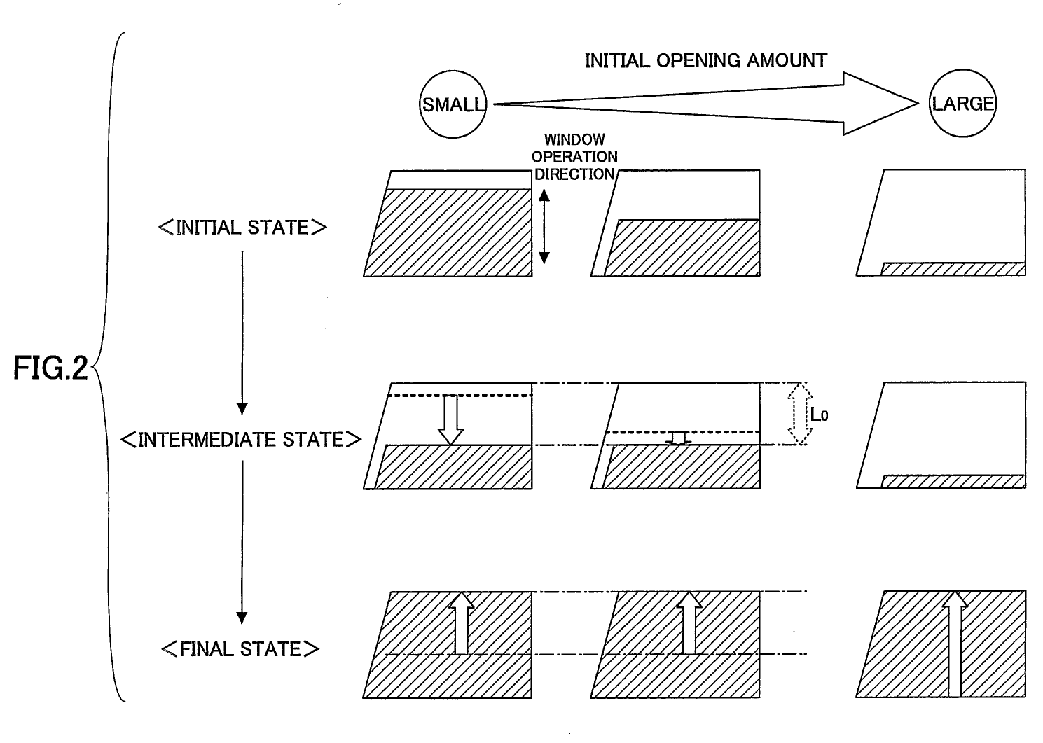

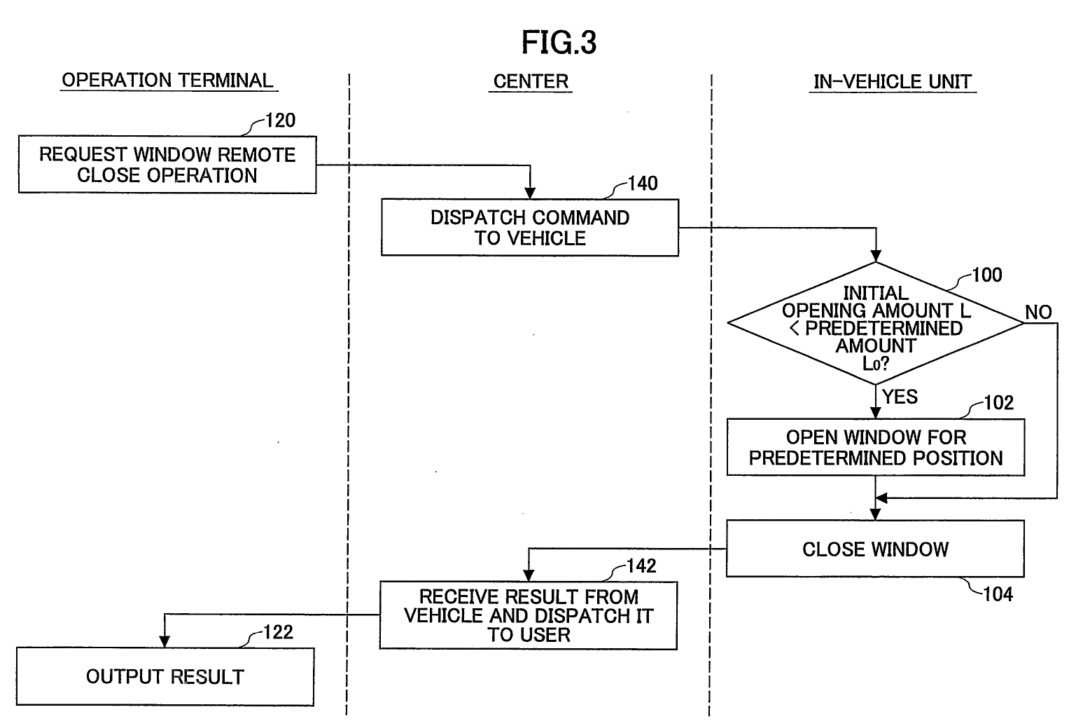

In the above-mentioned system, in general, the vehicle user operates the operation terminal 12 for the purpose of carrying out vehicle window remote closing in a condition where the vehicle user exists far away from the vehicle. As a result, the vehicle user can hardly make a sufficient safety check before actually carrying out window closing operation. Therefore, if window closing operation is suddenly carried out automatically, a person who rides in the vehicle or a person who is in the vicinity of the vehicle may encounter a less safe situation. In consideration of such a problem, the safety for such a vehicle window remote closing operation is directed to by the system according to the present embodiment, as will be described now with reference to FIGS. 2 and 3.

FIG. 2 illustrates window operation in a process of window remote closing operation. As an opening amount of the window when remote closing operation is requested (an opening amount at this timing is referred to as an initial opening amount, hereinafter) is smaller, an amount of safety degradation occurring due to window closing operation carried out from the initial position increases accordingly. However, when the window is once opened from the initial position before it is actually closed, a possibility that a human being who accidentally approaches the window is caught between the widow and the vehicle body is eliminated. That is, the person can be notified of the occurrence of window remote closing operation. Further, when the initial opening amount is larger than a predetermined amount, a safety can be ensured even when the window is directly closed from the initial position.

Therefore, when the remote operation request for window closing transmitted from the center 14 is received by the in-vehicle unit 10, it is determined first whether or not the window's initial opening amount has reached the predetermined amount. Then, when the initial opening amount has reached the predetermined amount, the window is driven to be directly closed from this initial position. On the other hand, when the initial opening amount has not reached the predetermined amount, the window is driven to be once opened, and after that, is driven to be closed. Thereby, the safety can be improved for remotely closing the window. When such window remote closing operation is carried out, opening operation carried out before the closing operation may be carried out for a position of a predetermined opening amount without regard to the initial position. Thereby, the safety for remote closing operation can be positively ensured.

A flow chart for realizing the above-mentioned function carried out in the remote control system according to the present embodiment is shown in FIG. 3. In the remote control system according to the present embodiment, the in-vehicle unit 10, the operation terminal 12 and the center 14 have respective software programs for carrying out functions described below, and operate according to the programs. The respective programs may be stored in computer readable information recording media, such as CDs, DVDs, hard disks, or such.

In the present embodiment, the operation terminal 12 obtains the web page for requesting remote operation provided by the center 14, then, in response to a transmission request made according to the vehicle user's operation on the web page in a state in which the check box for window closing operation is checked, the operation terminal 12 transmits the window remote closing operation request signal to the center 14 to notify it of this request (Step 120). Upon receiving with the transmitter-receiver 44 the window remote closing operation request signal transmitted from the operation terminal 12, the center 14 obtains the remote closing request, making a relation thereto from the identification information of the operation terminal 12 or the identification information of the vehicle corresponding to the operation terminal 12, and transmits the remote closing operation request to the in-vehicle unit 10 indicating that window remote closing driving operation is requested from the remote operation made on the operation terminal 12 (Step 140).

Upon receiving the window remote closing operation request signal transmitted from the center 14, the in-vehicle unit 10 provides the PW-ECU 26 via the in-vehicle ECU 20 of the closing instruction signal for driving the window to close it. Upon receiving the window closing instruction signal from the in-vehicle ECU 20, the PW-ECU 26 detects the current initial opening amount L of the window, and then, determines whether or not the thus-detected initial opening amount has reached the predetermined amount L0 (Step 100). The predetermined amount L0 is a minimum opening amount determined to ensure the safety even when the window is directly closed from the position. For example, the opening amount at which the PW-ECU 26 can properly carry out the catching detection function is applied.

When the PW-ECU 26 determines that L<L0 does not hold (No in Step 100) as a result, it can be determined that the safety can be ensured even when the window is directly closed from the state, and thus, the PW-ECU 26 gives instructions to the window opening/closing actuator 28 for closing the window. Thereby, the window is driven to be closed directly from the initial position (Step 104). On the other hand, when L<L0 holds (Yes in Step 100), it can be determined that the safety may not be ensured if the window is closed directly from the state. Accordingly, the PW-ECU 26 gives instructions to the window opening/closing actuator 28 for once opening the window, and thus, the window is driven to be opened so that the opening amount of the window may reach the predetermined amount L0 (Step 102). After the window is driven to be opened for the opening amount of the predetermined amount L0, the PW-ECU 26 gives instructions to the window opening/closing actuator 28 then for closing the window, and thus, the window is driven to be closed for the completely closed position (Step 104).

When the window opening/closing actuator 28 drives the window to open/close it, the window being opened/closed may be notified of to persons who ride in the vehicle or are in the vicinity of the vehicle, by means of the horn, the buzzer, or such of the voice/display output part 24. In this case, remote operation for the window is not carried out without a notification to the persons riding in the vehicle or in the vicinity thereof, but an attention to this matter is attracted. Accordingly, the safety for window remote operation is improved.

After carrying out the window closing operation as mentioned above, the in-vehicle unit 10 determines for a result of the remote operation (that is, whether the remote operation has been properly finished or has not been finished properly), and notifies the center 14 of this result. Upon receiving the notification of the driving result for the window remote closing operation from the in-vehicle unit 10 after transmitting the window remote closing operation request signal to the in-vehicle unit 10, the center 14 notifies the operation terminal 12 which transmitted the remote closing operation signal of this result by means of an electronic mail or such (Step 142). Upon receiving the driving result for the window remote closing operation notified of by the center 14, the operation terminal 12 displays this matter on the display device of the input/output part 34 or makes a voice output through the speaker so that the vehicle user may recognize the result. Then, the current processing is finished (Step 122).

Thus, according to the remote control system according to the present embodiment, when window remote closing operation is requested from the portable terminal 12 (operation terminal) to the in-vehicle unit 10 via the center 14, the window is once driven to be opened for the opening position of the predetermined opening amount L0 from the initial position, and after that, is driven to be closed to the closed position, when the initial opening amount L of the window at this time has not reached the predetermined amount L0. On the other hand, when the initial opening amount L of the window has reached the predetermined amount L0, the window is driven to be closed directly from the initial position for the closed position.

According to the preset embodiment, opening operation is thus carried out once, before closing operation of the window is carried out based on remote operation request. Since opening operation is safer and less dangerous than closing operation, it is possible to effectively prevent a person riding in the vehicle or a person in the vicinity of the vehicle from encountering a serious situation. Further, in the way, these persons can easily respond to the closing operation before the closing operation is actually carried out. Thus, a situation that a person is caught by the window due to remote closing operation of the window, or such, can be avoided. It is noted that, even when the window is directly closed when the window's initial opening amount L has already reached the predetermined amount L0 at a time of occurrence of remote operation request, a person riding in the vehicle or a person in the vicinity can have a sufficient time to respond thereto, whereby the safety can be ensured.

Accordingly, according to the present embodiment, the safety can be improved for carrying out remote closing operation of the window, and window's remote closing operation can be carried out appropriately taking into account the safety of persons who ride in the vehicle or come in the vicinity of the vehicle.

Further, in the present embodiment, the in-vehicle unit 10 has the catching detection function of detecting an object being caught between the window and the vehicle body for stopping the window closing operation as mentioned above. In this connection, if closing operation is carried out directly from a state where the window's initial opening amount L is small, the catching detection function may not properly work. That is, a positive catching detection may not be made. In contrast thereto, according to the present embodiment, opening operation is carried out once before closing operation is carried out based on remote operation request, when the window's initial opening amount L is smaller than the predetermined amount. Thereby, the window can be driven to be closed from the sufficient opening position in response to remote closing operation request. Thereby, according to the present embodiment, the catching detection function of the PW-ECU 26 can be made to positively work, and thus, a human body being caught by the window can be positively responded. Also from this point, the present embodiment can make it possible to carry out remote closing operation of the window positively taking into account the safety.

In the present embodiment, the in-vehicle 10 corresponds to a remote control apparatus, the window corresponds to an in-vehicle device, the predetermined amount L0 corresponds to a predetermined amount, and the position at which the window's opening amount reaches the predetermined amount L0 corresponds to a predetermined opening position.

In the present embodiment, closing operation of the window carried out based on remote closing operation request is carried out for the fully closed position. However, instead, closing operation may be carried out in this case for a not fully closed position but a position at which the window is opened for a predetermined opening amount.

Further, in the present embodiment, window opening operation carried out before closing operation based on remote closing operation request is carried out for the opening position corresponding to the predetermined amount L0. However, this opening operation may be carried out for the fully opened position instead. Also in this configuration, the same advantage as that obtained in the above-mentioned embodiment can be obtained. However, from an of antitheft viewpoint, driving of the window to open it in this case may be preferably carried out for the predetermined halfway opening amount P0 assuring the safety.

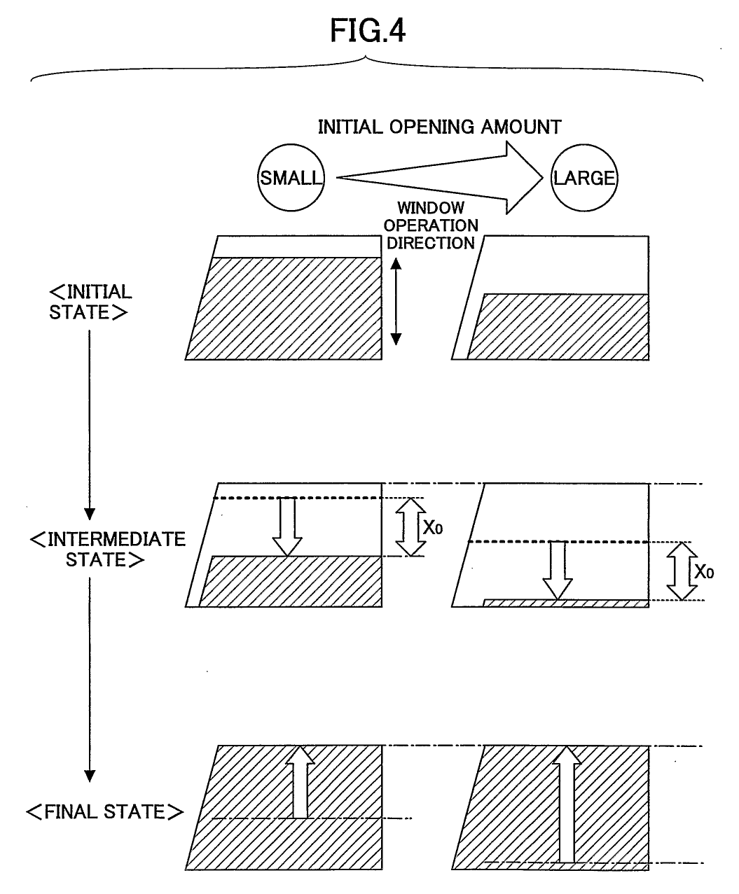

Further, in the above-mentioned embodiment, opening operation carried out before window closing operation carried out based on remote closing operation request is carried out for the predetermined opening position without regard to the initial opening position. However, as shown in FIG. 4, opening operation carried out in this case may be carried out by a predetermined moving amount X0. Also in this configuration, opening operation less dangerous is carried out from the initial position once before window closing operation is carried out. Accordingly, also in this configuration, a matter that window closing operation is carried out is notified of to a person who rides in the vehicle or a person in the vicinity of the vehicle, and the same advantage as that of the above-mentioned embodiment can be obtained.

Further, in the above-mentioned embodiment, the windows provided in the vehicle doors are targets for remote driving. However, the present invention is not limited thereto, and, for example, the present invention may also be applied to swinging doors, sliding doors, a back door, a sliding roof, or such, in the same manner.

Further, in the above-mentioned embodiment, the remote control system includes the in-vehicle unit 10 mounted in the vehicle, the operation terminal 12 carried by the vehicle user and the center 14 carrying out information management. However, the present invention is not limited thereto, and, for example, the present invention may also be applied to a system including the in-vehicle unit 10 and the operation terminal 12 without applying the center 14.

Further, in the above-mentioned embodiment, the operation terminal 12 is carried or possessed by the vehicle user. However, instead, a public telephone, a fixed telephone provided in a home, an information terminal unit installed in a convenience store or such, which the vehicle user does not always carry or possess, may also be applied as the operation terminal 12. In this case, vehicle control operation may be requested to the center 14 from the operation terminal 12 as a result of a predetermined button being pressed in a state in which the operation terminal 12 is connected with the center 14 via a communication line.

Further, in the above-mentioned embodiment, such an agreement may be previously made among persons concerned that, when a person rides in the vehicle or exists in the vicinity of the vehicle in a case where the in-vehicle unit 10 is remotely operated by means of operation of the operation terminal 12, a permission should be obtained from the person for the remote operation of the in-vehicle unit, and, the remote operation of the in-vehicle unit is actually carried out actually only after the permission has been obtained. Further, a configuration may be provided that, before remote operation of the in-vehicle unit is carried out, a current situation in the vehicle is shown to the vehicle user with the use of an in-vehicle camera, an in-vehicle microphone, or such, and, actual remote operation of the in-vehicle unit is carried out after the vehicle user has confirmed the vehicle situation thus shown.

Further, the present invention is not limited to the above-described embodiment, and variations and modifications may be made without departing from the basic concept of the present invention claimed below.

The present application is based on Japanese priority application No. 2004-288526, filed on Sep. 30, 2004, the entire contents of which are hereby incorporated herein by reference.

1. A remote control apparatus for driving an openable and closable in-vehicle device to close it remotely by means of operation made by a user on an operation terminal, wherein:
upon receiving a request for driving the in-vehicle device to close it, driving operation is carried out to open the in-vehicle device once before driving operation to close the same.

2. The remote control apparatus as claimed in claim 1, wherein:
the driving operation to open the in-vehicle device carried out before the driving operation to close the same is carried out by a predetermined amount.

3. The remote control apparatus as claimed in claim 1, wherein:
the driving operation to open the in-vehicle device carried out before the driving operation to close the same is carried out for a fully opened position.

4. The remote control apparatus as claimed in claim 1, wherein:
the driving operation to open the in-vehicle device carried out before the driving operation to close the same is carried out for a predetermined opening position.

5. A remote control apparatus for driving an openable and closable in-vehicle device to close it remotely by means of an operation made by a user on an operation terminal, wherein:
upon receiving a request for driving the in-vehicle device to close it, driving operation is carried out to open the in-vehicle device once before driving operation to close the same, when an opening amount of the in-vehicle device has not reached a predetermined amount; and the driving operation to close the in-vehicle device is carried out without driving operation to open the same, when the opening amount of the in-vehicle device has reached the predetermined amount.

6. The remote control apparatus as claimed in claim 1, wherein:
the driving operation to close the in-vehicle device is carried out for a fully closed position.

7. The remote control apparatus as claimed in claim 2, wherein:
the driving operation to close the in-vehicle device is carried out for a fully closed position.

8. The remote control apparatus as claimed in claim 3, wherein:
the driving operation to close the in-vehicle device is carried out for a fully closed position.

9. The remote control apparatus as claimed in claim 4, wherein:
the driving operation to close the in-vehicle device is carried out for a fully closed position.

10. The remote control apparatus as claimed in claim 5, wherein:
the driving operation to close the in-vehicle device is carried out for a fully closed position.
